(19) United States
(12) Patent Application Publication
(10) Pub. No.: US 2005/0013197 A1
(43) Pub. Date: Jan. 20, 2005

(54) MP4 multifunctional watch

(76) Inventors: Yi Shing Chung, Kwai Chung (HK); Tsoi Ying Chung, Kwai Chung (HK)

Correspondence Address: NATH & ASSOCIATES, 1030 15th STREET, NW, 6TH FLOOR, WASHINGTON, DC, 20005, US

(21) Appl. No.: 10/889,080

(22) Filed: Jul. 13, 2004

(30) Foreign Application Priority Data
Jul. 14, 2003 (CN) 03139802.2

(51) Int. Cl. G04B 47/00

(52) U.S. Cl. 368/10

(57) ABSTRACT

The present invention discloses a watch which has the function of playing and digital recording of a video-audio and image compressed software. The technical scheme is a MP4 multifunctional watch which comprises a MP4 video-audio and image playing unit and watch unit, in which the MP4 video-audio and image playing unit is mounted in a watch housing. By using the MP4 multifunctional watch, people not only receive accurate timing but also enjoy video and audio files and images whenever and wherever. Furthermore, the multifunctional watch is smaller in size, easier to be carried, with powerful multi-functions and convenient for operating.

### THE TECHNICAL FIELD

The present invention, in general, relates to a watch which has the function of playing and digital recording of a video-audio and image compressed software.

### THE BACKGROUND ART

Already in market today, the MP3 player can compress, store, decode and play an audio file. But for video file, there is no one single software which can compress more excellently for the video file, nor is there a playing medium which can support the software. Recently, there is a software, that is MP4, which is able to compress simultaneously an audio and video file into a smaller file. The characteristic of the software, which applies with the technology of MPEG-2AAC (abbreviated to a2b or aac), is able to compress an audio-video file into a rate of 1:15 in a smaller bit rate and a larger compressing rate so as to allow the audio and image quality thereof to be more perfectly, thereby achieving as an effect of CD or DVD. However, there is still not a medium player, which is more stable, at lower cost, smaller in size and easier to be carried so as to be suitable for people's consumption, and that can also support a MP4 software. Therefore, the earlier MP4 software has to be played in PC only, and it is limited to be applied in a very small range until now.

### THE INVENTIVE CONTENT

The object of the present invention is to provide a novel MP4 multifunctional watch which can overcome all the aforesaid deficiency so that people not just have it for accurate timing but also enjoy video-audio files and images whenever and wherever. Furthermore, the present multifunctional watch is smaller in size, easier to be carried and with more powerful multi-functions. It can be connected to many associated device and able to be operated conveniently.

According to an aspect of the present invention, the provided MP4 multifunctional watch, comprising a MP4 video-audio and image playing unit and a watch unit, characterizes in that the MP4 video-audio and image playing unit is mounted in a watch housing of the watch.

In the present MP4 multifunctional watch, the video-audio and image playing unit comprises a screen displaying panel, a control panel, a playing control circuit, a memory unit and a USB interface; wherein the control panel and the memory unit are connected to the playing circuit which is provided in a circuit board of the watch housing through circuits, respectively, and the playing circuit is connected to the USB interface.

In the MP4 multifunctional watch, the screen displaying panel may share one displaying panel with the watch, or to be provided with an individual displaying panel, more particularly, a TFT crystal image screen displaying panel which can display clearly video-audio, image, animation and file played by MP4, is preferable.

In the present MP4 multifunctional watch, the power supply unit of said displaying control circuit is a built-in rechargeable battery whose charging circuit is connected to an external charging circuit through the USB interface.

In the present MP4 multifunctional watch, the control panel comprises a plurality of control buttons which are used to control the playing of video-audio files and images of MP4 format as well as the music of MP3/WMA format.

In the present MP4 multifunctional watch, the control panel may be a board which is fixed on the watch housing and provided artificially with the plurality of control buttons; or it may be a board which is folded on the watch housing through an axis being fixed in the housing and provided artificially with the plurality of control buttons.

In the present MP4 multifunctional watch., the control panel sets a plurality of control buttons artificially on suitable positions on the periphery of the housing.

In the present MP4 multifunctional watch, the audio playing part of the playing control circuit is connected to external speakers through the USB interface.

In the present MP4 multifunctional watch, a recording microphone for collecting audio information or voice to be provided in the watch housing and connected to the recording circuit and the memory unit.

In the present MP4 multifunctional watch, a built-in flash memory disk is provided in the watch housing to be used as a movable flash disk.

For the present MP4 multifunctional watch which having the above structure, has not only provided all the functions and features of the normal watches, but has also combined skillfully with the functions of video-audio, image, animation and file played by MP4. Furthermore, it is functioned as a digital recorder and a movable hard disk, so that the present MP4 multifunctional watch is smaller in size, easier to be carried with powerful multi-functions, capable of connecting to a plurality of associated device and convenient for operating and using, thereby it is able to be played in different situations.

Such structure of the present MP4 multifunctional watch is not only suitable for wrist watch but also for the articles, such as pocket watches, accouterments of necklace, head accouterments and the like.

### THE SPECIFICATION OF THE DRAWINGS

FIG. 1 is a plan view of the MP4 multifunctional watch of the present invention.

FIG. 2 is a schematic view of the MP4 multifunctional watch of the present invention.

FIG. 3 is a schematic view showing the structure the MP4 multifunctional watch of the present invention.

FIG. 4 is a principle diagram showing the circuit of the MP4 multifunctional watch of the present invention.

### THE PREFERRED EMBODIMENTS

Further descriptions of the invention to be made in details by taking in conjunction with the figures provided.

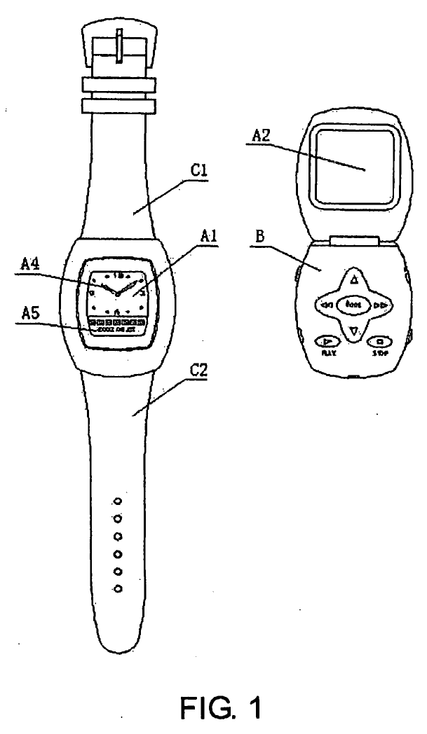

The structure of the present invention comprises a MP4 video-audio and image playing unit and a watch unit, the MP4 video-audio and image playing unit is mounted in a watch housing. As shown in FIG. 1, the displaying panel A1 of the watch part is known for time displayed by LCA. A4 acts as watch hands displaying timing, A5 displaying for week, calendar in LCD. Watch belts C1 and C2 are positioned in both ends of the watch housing. Further, the watch may be provided with the LCD timing by A5 and without the LCA crystal row pointer A4.

As shown in FIGS. 1, 2 and 3, the MP4 video-audio and image playing unit comprises a screen displaying panel A2, a control panel B, a playing control circuit B13, a memory unit B14 and a USB interface B4. Wherein the control panel B and the memory unit B14 are connected to a playing circuit B13 and B14 which is provided in the circuit board B13 and B14 of the watch housing through circuits, respectively, and the playing circuit B13 and B14 is connected to the USB interface B4. The screen displaying panel of the MP4 video-audio and image playing unit may share one displaying panel with the watch. That is to say, the displaying panel A1 and screen displaying panel A2 may be integrated into one panel or one displaying panel; A1 may be provided individually which particularly may be a TFT crystal image screen displaying panel for displaying clearly video-audio, image, animation and file played by MP4. Sharing one displaying panel results in a watch which is thinner, lower cost and follows the fashion. Furthermore, time is displayed by the crystal displaying panel other than the LCA watch hands A4, thereby control buttons may be provided on the control panel to switch the time picture of watch and the images played by the MP4. A TFT LCD back light color crystal displaying panel can be applied as the displaying panel.

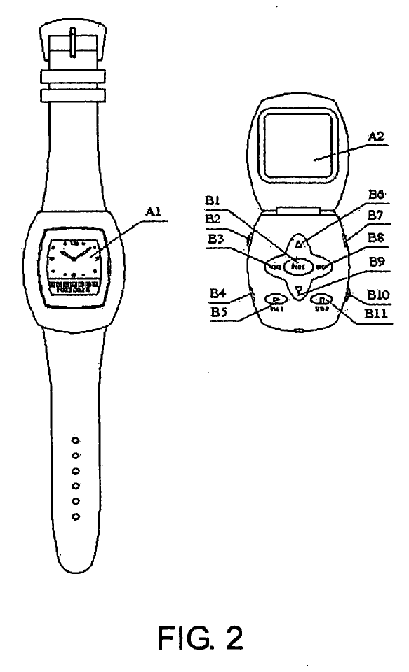

In the MP4 video-audio and image playing unit, the control panel B may be a board which is arranged artificially with a plurality of control buttons and folded on the housing through an axis being fixed in the housing. Also, the control panel B may be a board which is fixed on the watch housing and denotes a mode button, B3 denotes a rapid review back button, B5 denotes a playing button, B6 and B9 are volume/selection control buttons, B8 is a rapid forward button, B11 is a stop button, and playing functions are operated and controlled through these buttons and control circuits. Of course, the plurality of control buttons may be formed artificially on suitable positions on the periphery of the housing so that the control panel is omitted, such structure results in a watch which is thinner, lower cost and follows the fashion. Based on the desire of the consumer, the watch can be designed in the form illustrated FIGS. 1 and 2 which has a panel, or be designed in the form in which the control buttons are provided on positions on the periphery of the watch housing B2, which denotes a power supply switch button, and B4, which denotes a USB interface, are formed on the periphery of the watch housing In addition, the power supply switch button B2 tray be formed on the control panel B. It is noted that the designs and changes of the position of the control buttons should not impact on the relationships between the control circuits. The USB interface B4 is used for connecting to a computer for uploading and downloading and connecting externally to a speaker or earphones or power supply for charging. On the periphery of the watch, B7 denotes a recording microphone for collecting audio information and voice; B10 denotes a recording button which is connected to the memory unit B14 for storing the recorded audio information or voice in the memory unit or a memory unit of the computer, in addition, the recorded audio information can also be transmitted outwardly by e-mail. Of course, the recording button B10 may be disposed on the control panel. Furthermore, positions of above control buttons may be designed reasonably according to consumer's demands, appearance of product and the technical scheme.

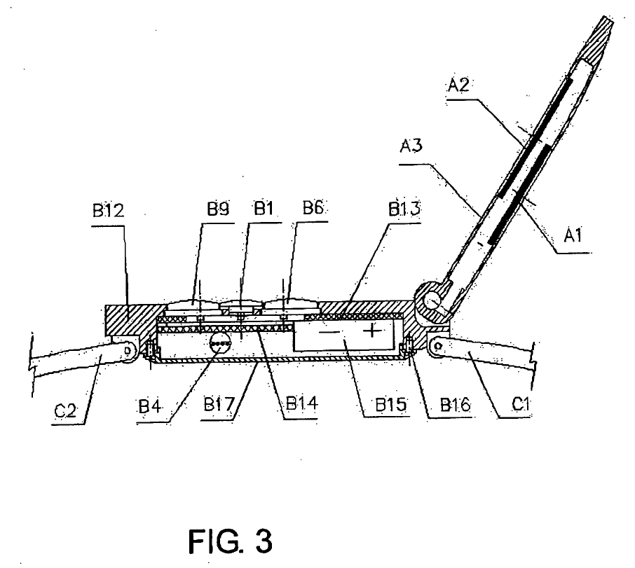

As shown in FIG. 3, in the video-audio and image playing unit of the MP4 multifunction watch according to the present invention, B12 denotes the watch housing and both ends thereof are connected to watch belts C1 and C2, respectively. B13 denotes the MP4 control circuit, B14 denotes a flash disk memory unit such that all video-audio video files of MP4 or music files of MP3 and recorded audio or voice files can be stored therein. The watch is companied with people so as to play wherever and whenever. It also can be used as a movable flash disk. B15 denotes a built-in rechargeable environmental protection battery, especially for lithium battery, whose charging circuit is connected to the external charging circuit through the USB interface. The external charging circuit may be charged directly from the computer through the USB interface and also obtains electric energy from the AC power supply through the charger with the USB interface. B16 denotes a screw for connecting and fixing the watch housing B12 to a bottom cover B17. A3 denotes upper cover of the watch housing, and the LCD panel A1 and MP4 TFT crystal displaying panel A2 are disposed upper surface and lower surface of the watch housing, respectively.

In use, similarly to a normal watch for timing, it is able to obtain time information by observing directly to the displaying panel. When using the MP4 video-audio and image playing unit, firstly, turning on the power supply control button B2; then, adjusting mode button B1; then, selecting the menu in display; and then, pressing playing button B5, thereby watching the content stored in the memory unit. It may be connected to other computer or Internet through USB cable and the USB interface B4 to obtain other information according to the operation stated above. Furthermore, both external charging and external connecting to a speaker may be accomplished through USB cable and the USB interface B4.

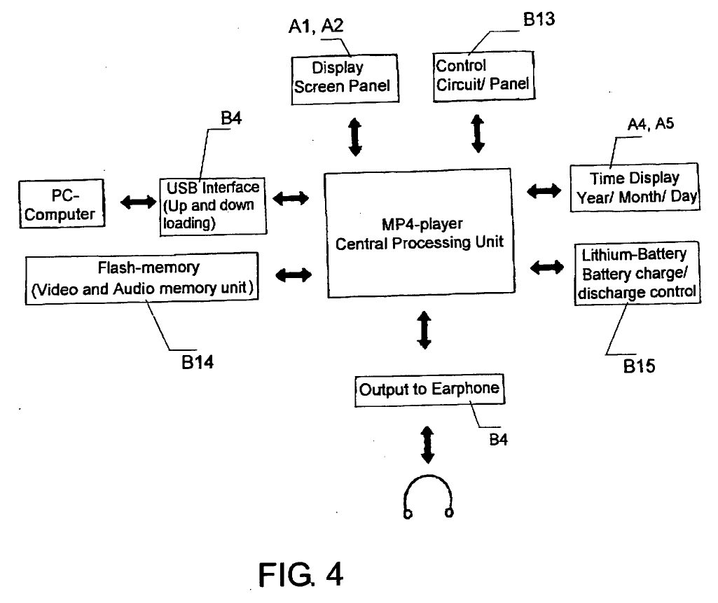

FIG. 4 shows a circuit principle diagram of the MP4 multifunctional watch of the present invention.

1. A MP4 multifunctional watch, comprising a MP4 video-audio and image playing unit and a watch unit, in which the MP4 video-audio and image playing unit is mounted in a watch housing of the watch.

2. The MP4 multifunctional watch according to claim 1, wherein said video-audio and image playing unit comprises a screen displaying panel, a control panel, a playing control circuit, a memory unit and a USB interface, wherein the control panel and the memory are connected to a playing circuit which is provided in the circuit board of the watch housing through circuits, respectively, and the playing circuit is connected to the USB interface.

3. The MP4 multifunctional watch according to claim 2, wherein said screen displaying panel shares one displaying panel with the watch, or is provided with an individual displaying panel, more particularly, a TFT crystal image screen displaying panel which can display clearly video-audio, image, animation and file played by MP4.

4. The MP4 multifunctional watch according to claim 2, wherein the power supply part of said displaying control circuit is an built-in rechargeable battery whose charging circuit is connected to an external charging circuit though the USB interface.

5. The MP4 multifunctional watch according to claim 2, wherein said control panel comprises a plurality of control buttons which are used for playing video-audio files and images of MP4 format as well as the music of MP3/WMA format.

6. The MP4 multifunctional watch according to claims 2 or 5, wherein said control panel is a board which is fixed on the watch housing and arranged artificially with the plurality of control buttons; or a board which is folded on the housing through an axis being fixed in the housing and arranged artificially with the plurality of control buttons.

7. The MP4 multifunctional watch according to claims 2 or 5, wherein said control panel sets the plurality of control buttons artificially on suitable positions on the periphery of the housing

8. The MP4 multifunctional watch according to claim 2, wherein the audio playing part of the playing control circuit is connected to an external speaker through the USB interface.

9. The MP4 multifunctional watch according to claim 1, wherein a recording microphone for collecting audio information is provided in the watch housing and connected to the recording circuit and the memory unit.

10. The MP4 multifunctional watch according to claim 1, wherein an built-in flash memory disk is provided in the watch housing to be used as a movable flash disk.
